(19) United States
(12) Patent Application Publication
(10) Pub. No.: US 2018/0342078 A1
(43) Pub. Date: Nov. 29, 2018

(54) INFORMATION PROCESSING DEVICE, INFORMATION PROCESSING METHOD, AND INFORMATION PROCESSING SYSTEM

(71) Applicant: SONY CORPORATION, TOKYO (JP)

(72) Inventor: SHINJI WATANABE, TOKYO (JP)

(21) Appl. No.: 15/761,572

(22) PCT Filed: Jul. 7, 2016
(86) PCT No.: PCT/JP2016/070121

§ 371 Date: Mar. 20, 2018

(30) Foreign Application Priority Data
Oct. 8, 2015 (JP) 2015-199990

(51) Int. Cl. G06T 7/73; G06T 7/00; G06K 9/00

(52) U.S. Cl. CPC G06T 7/73; G06T 7/0012; G06T 2207/20081; G06T 2207/20104; G06K 9/00127

(57) ABSTRACT

[Object] To enable analysis of a change of a cell with high accuracy. [Solution] Provided is an information processing device including: a detector decision unit configured to decide at least one detector in accordance with an analysis method; and an analysis unit configured to perform analysis according to the analysis method using the at least one detector decided by the detector decision unit.

### TECHNICAL FIELD

The present disclosure relates to an information processing device, an information processing method, and an information processing system.

### BACKGROUND ART

In research conducted in the fields of medical and biological sciences, changes such as motions, growth, metabolism, or proliferation of many types of cells are observed and analyzed. However, observation of cells that depends on visual recognition by observers mostly reflects subjectivity of the observers, and thus objective analysis results are difficult to obtain. Thus, technologies of analyzing changes of cells by analyzing images obtained by capturing images of the cells have been developed in recent years.

In order to analyze a region corresponding to a cell included in a captured image, it is necessary to select an appropriate algorithm for detecting the cell. For example, Patent Literature 1 mentioned below discloses a technology in which a plurality of region extraction algorithms are executed for a plurality of pieces of image data and an algorithm which enables characteristics of a region of interest included in an image designated by a user to be extracted with highest accuracy is selected. In addition, Patent Literature 2 mentioned below discloses a technology for analyzing a cell by selecting an algorithm in accordance with a type of the cell.

### CITATION LIST

### Patent Literature

Patent Literature 1: JP 5284863B

Patent Literature 2: JP 4852890B

### DISCLOSURE OF INVENTION

### Technical Problem

However, since an algorithm is decided in accordance with a characteristic of a cell appearing in one image in the technology disclosed in the above-mentioned Patent Literature 1, it is difficult to analyze a change of the cell, such as growth or proliferation, using the decided algorithm in the case where the change of the cell occurs. In addition, since a detector for analyzing a state of a cell at a certain time point is selected on the basis of a type of the cell in the technology disclosed in the above-mentioned Patent Literature 2, it is difficult to continuously analyze a temporal change in a shape or a state of the cell such as proliferation or cell death of the cell.

Thus, the present disclosure proposes a novel and improved information processing device, information processing method, and information processing system that enable analysis of a change of a cell with high accuracy.

### Solution to Problem

According to the present disclosure, there is provided an information processing device including: a detector decision unit configured to decide at least one detector in accordance with an analysis method; and an analysis unit configured to perform analysis according to the analysis method using the at least one detector decided by the detector decision unit.

In addition, according to the present disclosure, there is provided an information processing method including: deciding at least one detector in accordance with an analysis method; and performing analysis according to the analysis method using the at least one decided detector.

In addition, according to the present disclosure, there is provided an information processing system including: an imaging device that includes an imaging unit configured to generate a captured image; and an information processing device that includes a detector decision unit configured to decide at least one detector in accordance with an analysis method, and an analysis unit configured to perform analysis on the captured image in accordance with the analysis method using the at least one detector decided by the detector decision unit.

### Advantageous Effects of Invention

According to the present disclosure described above, a change of a cell can be analyzed with high accuracy.

Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is a diagram showing an overview of a configuration of an information processing system according to an embodiment of the present disclosure.

FIG. 2 is a block diagram showing an example of a configuration of an information processing device according to a first embodiment of the present disclosure.

FIG. 3 is a table for describing detection recipes according to the embodiment.

FIG. 4 is a table showing examples of detection recipes corresponding to analysis methods.

FIG. 5 is a diagram showing an example of an interface for inputting adjustment details into a detection parameter adjustment unit according to the embodiment.

FIG. 6 is a flowchart showing an example of a process performed by the information processing device according to the embodiment.

FIG. 7 is a diagram showing an example of a captured image generated by an imaging device according to the embodiment.

FIG. 8 is a diagram showing an example of a drawing process performed by a region drawing unit according to the embodiment.

FIG. 9 is a diagram showing an example of output of an output control unit according to the embodiment.

FIG. 10 is a diagram showing a first output example of a narrowing process for regions of interest performed by a plurality of detectors according to the embodiment.

FIG. 11 is a diagram showing a second output example of the narrowing process for regions of interest performed by the plurality of detectors according to the embodiment.

FIG. 12 is a block diagram showing an example of a configuration of an information processing device according to a second embodiment of the present disclosure.

FIG. 13 is a diagram showing an example related to a shape setting process for a region of interest performed by a shape setting unit according to the embodiment.

FIG. 14 is a diagram showing an example related to a specification process of a region of interest performed by a region specification unit according to the embodiment.

FIG. 15 is a block diagram showing an example of a hardware configuration of an information processing device according to an embodiment of the present disclosure.

### MODE(S) FOR CARRYING OUT THE INVENTION

Hereinafter, (a) preferred embodiment(s) of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that description will be provided in the following order.

1. Overview of information processing system

### 2. First Embodiment

2.1. Example of configuration of information processing device
2.2. Example of process of information processing device

### 2.3. Effect

2.4. Application example

### 3. Second Embodiment

3.1. Example of configuration of information processing device

### 3.2. Effect

4. Example of hardware configuration

### 5. Conclusion

### 1. OVERVIEW OF INFORMATION PROCESSING SYSTEM

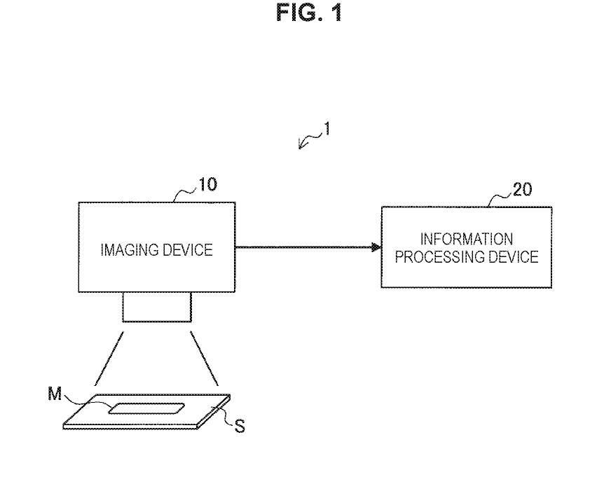

FIG. 1 is a diagram showing an overview of a configuration of an information processing system 1 according to an embodiment of the present disclosure. As shown in FIG. 1, the information processing system 1 is provided with an imaging device 10 and an information processing device 20. The imaging device 10 and the information processing device 20 are connected to each other via various types of wired or wireless networks.

### (Imaging Device)

The imaging device 10 is a device which generates captured images (dynamic images). The imaging device 10 according to the present embodiment is realized by, for example, a digital camera. In addition, the imaging device 10 may be realized by any type of device having an imaging function, for example, a smartphone, a tablet, a game device, or a wearable device. The imaging device 10 images real spaces using various members, for example, an image sensor such as a charge coupled device (CCD) or a complementary metal oxide semiconductor (CMOS), a lens for controlling formation of a subject image in the image sensor, and the like. In addition, the imaging device 10 includes a communication device for transmitting and receiving captured images and the like to and from the information processing device 20. In the present embodiment, the imaging device 10 is provided above an imaging stage S to image a culture medium M in which a cell that is an analysis target is cultured. In addition, the imaging device 10 generates dynamic image data by imaging the culture medium M at a specific frame rate. Note that the imaging device 10 may directly image the culture medium M (without involving another member), or may image the culture medium M via another member such as a microscope. In addition, although the frame rate is not particularly limited, it is desirable to set the frame rate according to the degree of a change of the analysis target. Note that the imaging device 10 images a given imaging region including the culture medium M in order to accurately track a change of the observation target. Dynamic image data generated by the imaging device 10 is transmitted to the information processing device 20.

Note that, although the imaging device 10 is assumed to be a camera installed in an optical microscope or the like in the present embodiment, the present technology is not limited thereto. For example, the imaging device 10 may be an imaging device included in an electronic microscope using electron beams such as a scanning electron microscope (SEM) or a transmission electron microscope (TEM), or an imaging device included in a scanning probe microscope (SPM) that uses a probe such as an atomic force microscope (AFM) or a scanning tunneling microscope (STM). In this case, a captured image generated by the imaging device 10 is, for example, an image obtained by irradiating the observation target with electron beams in the case of an electronic microscope, and an image obtained by tracing the observation target using a probe in the case of an SPM. These captured images can also be analyzed by the information processing device 20 according to the present embodiment.

### (Information Processing Device)

The information processing device 20 is a device having an image analyzing function. The information processing device 20 is realized by any type of device having an image analyzing function such as a personal computer (PC), a tablet, or a smartphone. In addition, the information processing device 20 may be realized by one or a plurality of information processing devices on a network. The information processing device 20 according to the present embodiment acquires a captured image from the imaging device 10 and executes tracking of a region of the observation target in the acquired captured image. The result of analysis of the tracking process performed by the information processing device 20 is output to a storage device or a display device provided inside or outside the information processing device 20. Note that a functional configuration that realizes each function of the information processing device 20 will be described below.

Note that, although the information processing system 1 is constituted with the imaging device 10 and the information processing device 20 in the present embodiment, the present technology is not limited thereto. For example, the imaging device 10 may perform a process related to the information processing device 20 (for example, a tracking process). In this case, the information processing system 1 is realized by the imaging device having the function of tracking an observation target.

Here, cells that are observation targets undergo various kinds of phenomena such as growth, division, conjugation, deformation, or necrosis in a short period of time, unlike ordinary subjects such as human beings, animals, plants, biological tissues, or structures that are non-living objects. Thus, in the technology disclosed in the specification of JP 5284863B, for example, a detector is selected on the basis of an image of a cell of a certain time point, and thus in a case in which a cell changes its shape or state, it is difficult to analyze the cell using the same detector. In addition, in the technology disclosed in the specification of JP 4852890B, since a detector for analyzing a state of a cell of a certain time point is selected in accordance with the type of cell, it is difficult to continuously analyze a temporal change in a shape or a state of the cell such as proliferation or cell death of the cell. Thus, analysis or evaluation of changes of cells is difficult to perform in the technology disclosed in the above documents. Furthermore, even if an observation target is an animal, a plant, or a structure that is a non-living object, in a case in which a structure or a shape of the observation target significantly changes in a short period of time, like growth of a thin film or nano-cluster crystal or the like, it is difficult to continuously analyze the observation target in accordance with a type of observation.

Therefore, the information processing system 1 according to the present embodiment selects a detector associated with an analysis method or an evaluation method for an observation target from a detector group and performs analysis using the selected detector. According to the technology, by selecting the analysis method for analyzing or the evaluation method for evaluating a change of an observation target, an observation target that causes a change can be detected in accordance with the analysis method or the like, and thus the observation target can be analyzed. Accordingly, the change of the observation target can be analyzed with higher accuracy. Note that the information processing system 1 according to the present embodiment is assumed to be mainly used to evaluate changes of observation targets, or the like. However, changes of observation targets, or the like are evaluated on the premise of analysis of the changes of the observation targets and the like. For example, in a case in which a user performs evaluation AA on an observation target using the information processing system 1, if an analysis method necessary for the evaluation AA is BB or CC, the information processing system 1 performs analysis on the observation target using the analysis method BB or CC. That is, performing analysis using a detector selected in accordance with an evaluation method is included in performing analysis using a detector selected in accordance with an analysis method. Thus, the present disclosure will be described on the assumption that an analysis method includes an evaluation method.

The overview of the information processing system 1 according to an embodiment of the present disclosure has been described above. The information processing device 20 included in the information processing system 1 according to an embodiment of the present disclosure is realized in a plurality of embodiments. A specific configuration example and an operation process of the information processing device 20 will be described below.

### 2. FIRST EMBODIMENT

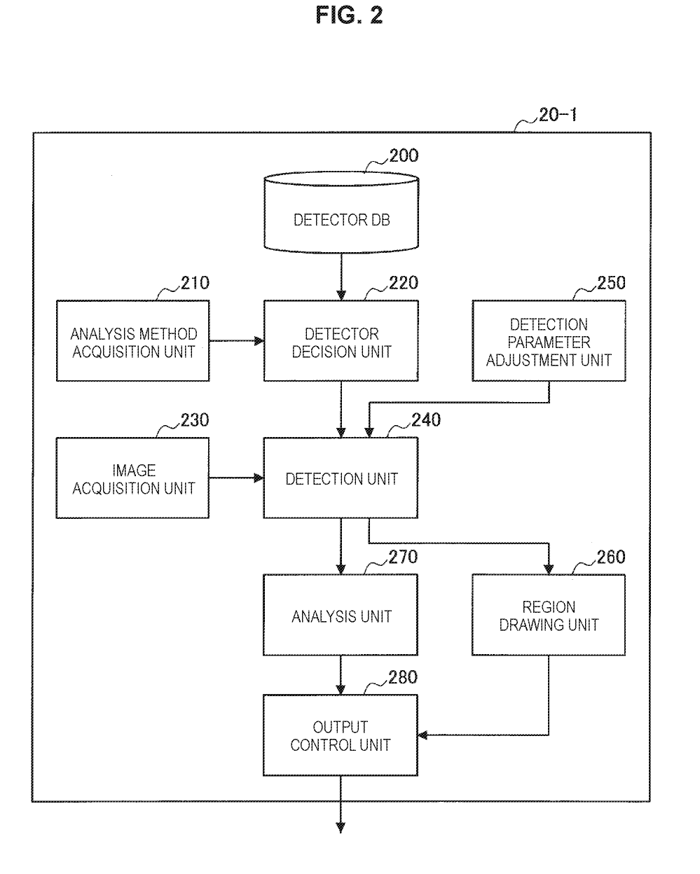

First, an information processing device 20-1 according to a first embodiment of the present disclosure will be described with reference to FIGS. 2 to 11.

### 2.1. Example of Configuration of Information Processing Device

FIG. 2 is a block diagram showing an example of a configuration of the information processing device 20-1 according to the first embodiment of the present disclosure. As shown in FIG. 2, the information processing device 20-1 includes a detector database (DB) 200, an analysis method acquisition unit 210, a detector decision unit 220, an image acquisition unit 230, a detection unit 240, a detection parameter adjustment unit 250, a region drawing unit 260, an analysis unit 270, and an output control unit 280.

### (Detector DB)

The detector DB 200 is a database which stores detectors necessary for detecting analysis targets. A detector stored in the detector DB 200 is used to calculate a feature amount from a captured image obtained by capturing an observation target and detects a region corresponding to the observation target on the basis of the feature amount. The detector DB 200 stores a plurality of detectors and these detectors are optimized in accordance with an analysis method or an evaluation method performed for each of specific observation targets. For example, a plurality of detectors are associated with specific changes in order to detect a certain specific change of an observation target. A set of a plurality of detectors for detecting such a specific change will be defined as a “detection recipe” in the present specification. A combination of detectors included in a detection recipe is decided in advance for, for example, each observation target and each phenomenon in which the observation target can be manifested.

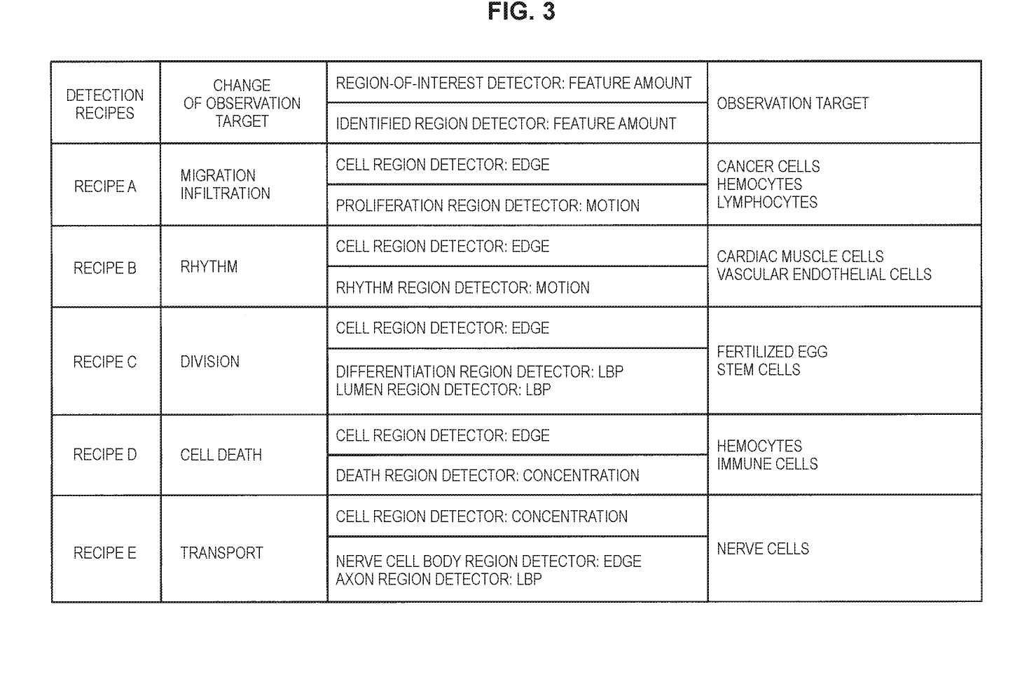

FIG. 3 is a table for describing detection recipes according to the present embodiment. As shown in FIG. 3, the detection recipes are associated with changes of cells that are observation targets (and the observation targets) and have detectors for detecting the associated changes of the cells (and corresponding feature amounts). A feature amount is a variable used to detect an observation target.

Here, there are two types of detectors including a region-of-interest detector and an identified region detector as detectors stored in the detector DB 200 as shown in FIG. 3. The region-of-interest detector is a detector for detecting a region in which an observation target is present in a captured image. The region-of-interest detector includes, for example, a cell region detector in a case in which observation targets are various types of cells. The region-of-interest detector is used to detect a region in which an observation target is present by calculating a feature amount, for example, an edge, concentration, or the like.

On the other hand, the identified region detector is a detector for detecting a region that is changing from a part of or an entire observation target in a captured image. The identified region detector includes, for example, in a case in which observation targets are various types of cells, a proliferation region detector, a rhythm region detector, a differentiation region detector, a lumen region detector, a death region detector, a nerve cell body region detector, an axon region detector, and the like. The identified region detector is used to detect a changed region of an observation target by calculating a feature amount of, for example, a motion, local binary patterns (LBPs) between a plurality of frames, or the like. Accordingly, a unique change found in the observation target can be easily analyzed.

The above-described detection recipes each have a region-of-interest detector and an identified region detector. By using such detection recipes, regions corresponding to an observation target (regions of interest) can be detected, and a region in which a change of the observation target occurs can be further identified among the regions of interest. Note that, in a case in which simple analysis is performed with regard to a region corresponding to an observation target (e.g., a case in which a size, a movement, or the like of a cell region is analyzed), each detection recipe may include only a region-of-interest detector. In addition, in a case in which only one region corresponding to an observation target is included in a captured image or in a case in which no regions corresponding to individual observation targets may be detected for analysis of observation targets, each detection recipe may include only an identified region detector.

As shown in FIG. 3, for example, a detection recipe A is a detection recipe for detecting a change such as migration or infiltration of a cell. Thus, the detection recipe A includes a cell region detector for detecting a region of a cell, and a proliferation region detector for detecting a proliferation region of the cell in which the cell causes migration or infiltration. In a case in which infiltration of a cancer cell is analyzed, a region corresponding to the cancer cell can be detected using the cell region detector and further a region in which the cancer cell causes infiltration can be detected using the proliferation region detector by selecting the detection recipe A.

Note that the detection recipe A may be prepared for each of observation targets, for example, a detection recipe Aa for detecting cancer cells, a detection recipe Ab for detecting hemocytes, and a detection recipe Ac for detecting lymphocytes. This is because observation targets each have different characteristics to be detected.

In addition, a plurality of identified region detectors may be included in one detection recipe, like a detection recipe C and a detection recipe E. Accordingly, even in a case in which a new observation target having a different characteristic due to differentiation of a cell or the like is generated, for example, the new observation target can be subject to detection and analysis, without employing a new detector corresponding to the observation target again. In addition, even in a case in which one observation target has a plurality of different characteristics, a region having a specific characteristic can be identified and analyzed.

These detectors can be optimized for detection of observation targets with high accuracy. The above-described detectors, for example, may be generated through machine learning in which a set of an analysis method or an evaluation method for an observation target and a captured image including an image of the observation target is used as learning data. Although it will be described in detail below, an analysis method or an evaluation method for an observation target is associated with at least one detection recipe. For this reason, by performing machine learning in advance using a captured image including an image of an observation target that is a target of an analysis method or an evaluation method corresponding to a detection recipe, detection accuracy can be improved.

Note that a feature amount to be used in an identified region detector may include time series information, for example, vector data, and the like. This is, for example, to detect a degree of a temporal change of a region of an observation target desired to be identified with higher accuracy.

The above-described machine learning may be machine learning using, for example, boosting, a support vector machine, or the like. According to this technology, a detector with respect to a feature amount shared by images of a plurality of observation targets is generated. A feature amount used in this technology may be, for example, an edge, LBT, Haar-like feature amount, or the like. In addition, deep learning may be used as machine learning. Since a feature amount for detecting such a region is automatically generated in deep learning, a detector can be generated only by performing machine learning with respect to a set of learning data.

### (Analysis Method Acquisition Unit)

The analysis method acquisition unit 210 acquires information regarding an analysis method or an evaluation method for analyzing an observation target (the evaluation method and the analysis method will be referred to together as an “analysis method” below since the evaluation method is included in the analysis method as described above). For example, the analysis method acquisition unit 210 may acquire an analysis method input by a user through an input unit, which is not illustrated, when an observation target is to be analyzed using the information processing device 20-1. In addition, when analysis is performed in accordance with a pre-determined schedule, for example, the analysis method acquisition unit 210 may acquire an analysis method from a storage unit, which is not illustrated, at a predetermined time point. Furthermore, the analysis method acquisition unit 210 may acquire the analysis method via a communication unit which is not illustrated.

The analysis method acquisition unit 210 acquires information regarding the analysis method (evaluation method), for example, “scratch assay for cancer cells,” “efficacy evaluation of cardio muscle cells,” or the like. In a case in which the analysis method is only for “analysis of a size,” “analysis of a motion,” or the like, the analysis method acquisition unit 210 may also acquire information regarding a type of a cell that is an observation target, in addition to the analysis method.

The information regarding the analysis method acquired by the analysis method acquisition unit 210 is output to the detector decision unit 220.

### (Detector Decision Unit)

The detector decision unit 220 decides at least one detector in accordance with the information regarding the analysis method acquired from the analysis method acquisition unit 210. For example, the detector decision unit 220 decides a detection recipe associated with the type of the acquired analysis method and acquires a detector included in the detection recipe from the detector DB 200.

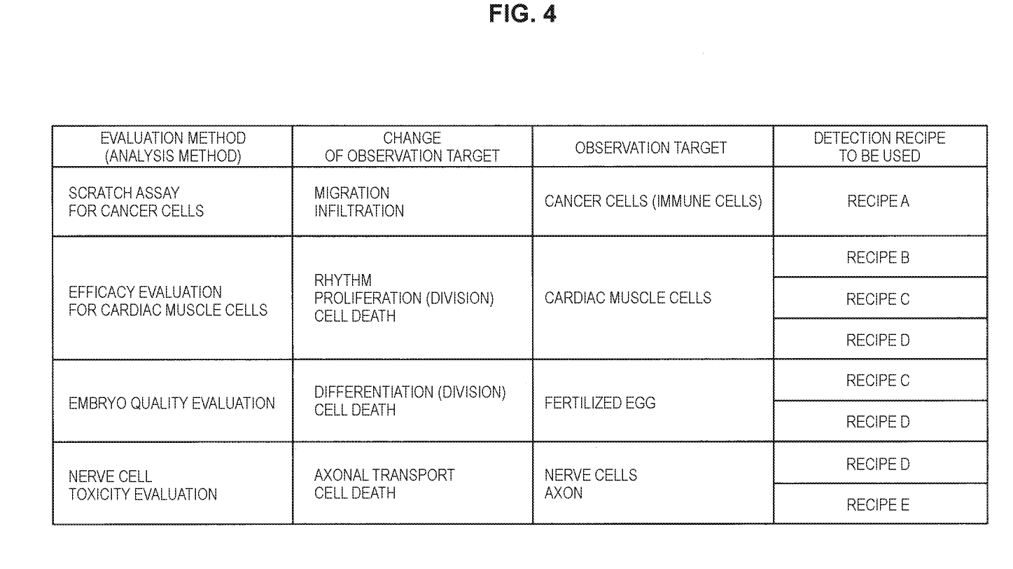

FIG. 4 is a table showing examples of detection recipes corresponding to analysis methods. As shown in FIG. 4, one analysis method is associated with at least one change (and the type of an observation target) of a cell that is an observation target. This is because analysis of a cell is performed with respect to a specific change of the cell. In addition, each change of the observation target is associated with a detection recipe as shown in FIG. 3. Thus, if an analysis method is decided, a detector to be used in a detection process is decided as well in accordance with the analysis method.

In a case in which scratch assay for cancer cells is performed as evaluation as shown in FIG. 4, for example, the detector decision unit 220 decides the detection recipe A corresponding to scratch assay for cancer cells. This is because scratch assay for cancer cells is for evaluating migration and infiltration of cancer cells. The detection recipe A decided here may be the detection recipe Aa corresponding to cancer cells. Accordingly, detection accuracy and analysis accuracy can be further improved. The detector decision unit 220 acquires a detector included in the detection recipe A from the detector DB 200.

In addition, in a case in which efficacy evaluation for cardio muscle cells is performed, the detector decision unit 220 decides a detection recipe B, a detection recipe C, and a detection recipe D as detection recipes corresponding to efficacy evaluation for cardio muscle cells. This is because rhythms, proliferation, division, cell death, and the like of cardio muscle cells are evaluated as efficacy evaluation for cardio muscle cells through administration. In this case, the detection recipe B corresponding to rhythms, the detection recipe C corresponding to proliferation and division, and the detection recipe D corresponding to cell death are decided. By performing detection using detectors included in these detection recipes, a region of the cardio muscle cells in which the cells have rhythms, a region in which the cells are being divided, and a region in which cell death are shown, or the like can each be discriminated. Accordingly, more reliable analysis results can be obtained.

Further, the detector decision unit 220 can also perform analysis as will be described below by deciding a plurality of detectors in accordance with analysis methods. For example, there is a case in which simultaneous analysis is desired to be performed on a plurality types of cells. In this case, the detector decision unit 220 can analyze a plurality of types of cells at a time by acquiring detectors each in accordance with a plurality of analysis methods. Accordingly, in a case in which fertilization is analyzed, for example, each of an ovum and a sperm can be detected and analyzed. In addition, in a case in which interaction between cancer cells and immune cells is desired to be analyzed, the two kinds of cells can each be detected and analyzed. Furthermore, cells included in a blood cell group (red blood cells, white blood cells, platelets, or the like) can also be identified.

In addition, there is a case in which a change in a course of cell growth is desired to be identified. In this case, by deciding a detection recipe including a plurality of detectors optimized for a change in a shape caused by growth, cells whose shapes are being changed can be continuously analyzed. Accordingly, for example, growth and changes of axons of nerve cells, changes in shapes of cultured cells forming a colony in a culture medium, changes in the shape of a fertilized egg, and the like can be traced and analyzed.

Furthermore, there is a case in which a test in which cells can exhibit a plurality of reactions is desired to be evaluated. In this case, by deciding a detection recipe including a plurality of detectors corresponding to feasible shapes or states of cells, the plurality of reactions of a cell group can be comprehensively evaluated. Accordingly, for example, changes in shapes of cells, pulses, life and death, changes in proliferation capabilities, and the like in an efficacy evaluation and a toxicity assessment can be comprehensively analyzed.

The functions of the detector decision unit 220 have been described above. Information regarding a detector decided by the detector decision unit 220 is output to the detection unit 240.

### (Image Acquisition Unit)

The image acquisition unit 230 acquires image data including a captured image generated by the imaging device 10 via a communication device that is not illustrated. For example, the image acquisition unit 230 acquires dynamic image data generated by the imaging device 10 in a time series manner. The acquired image data is output to the detection unit 240.

Note that images that the image acquisition unit 230 acquires include an RGB image, a grayscale image, or the like. In a case in which an acquired image is an RGB image, the image acquisition unit 230 converts the captured image that is the RGB image into a grayscale image.

### (Detection Unit)

The detection unit 240 detects a region of interest in the captured image acquired by the image acquisition unit 230 using the detector decided by the detector decision unit 220. A region of interest is a region corresponding to an observation target as described above.

For example, the detection unit 240 detects a region within the captured image corresponding to the observation target by using the region-of-interest detector included in the detection recipe. In addition, the detection unit 240 detects a region in which a specific change occurs in the observation target by using the identified region detector included in the detection recipe.

More specifically, the detection unit 240 calculates a feature amount designated by the detector from the acquired captured image and generates feature amount data related to the captured image. The detection unit 240 detects a region of interest in the captured image using the feature amount data. As an algorithm used by the detection unit 240 to detect a region of interest, for example, boosting, support vector machine, or the like is exemplified. The feature amount data generated for the captured image is data regarding the feature amount designated by the detector that the detection unit 240 uses. Note that, in a case in which a detector that the detection unit 240 uses is generated using a learning method in which no feature amount needs to be set in advance, such as deep learning, the detection unit 240 calculates a feature amount automatically set by the detector using a captured image.

In addition, in a case in which the detection recipe decided by the detector decision unit 220 includes a plurality of detectors, the detection unit 240 may detect regions of interest using each of the plurality of detectors. In this case, for example, the detection unit 240 may detect a region of interest using the region-of-interest detector, and further detect a region that is desired to be further identified from the previously detected region of interest using the identified region detector. Accordingly, a specific change of the observation target to be analyzed can be closely detected.

The detection unit 240 is assumed to detect an observation target using, for example, the detection recipe A (refer to FIG. 3) decided by the detector decision unit 220. The detection recipe A includes the cell region detector and the proliferation region detector for cancer cells. The detection unit 240 can detect a region corresponding to a cancer cell using the cell region detector and further can detect a region in which a cancer cell causes infiltration using the proliferation region detector.

Note that the detection unit 240 may perform a process for associating the detected region of interest with an analysis result obtained through analysis performed by the analysis unit 270. Although it will be described below in detail, the detection unit 240, for example, may give an ID for identifying an analysis method or the like to the detected region of interest. Accordingly, it is possible to easily manage analysis results each obtained in, for example, a post-analysis process for each region of interest. In addition, the detection unit 240 may decide a value of an ID given to each region of interest in accordance with detection results of the plurality of detectors. For example, the detection unit 240 may give a number for identifying a detected region of interest to a latter place of a multiple-digit ID and give a number corresponding to a detector used in detection of the region of interest to a former place thereof. More specifically, the detection unit 240 may give IDs of “10000001” and “10000002” to two regions of interest that are detected using a first detector and give an ID of “00010001” to one region of interest that is detected using a second detector. In addition, in a case in which one region of interest can be detected using any of the first and second detectors, the detection unit 240 may give an ID of “10010001” to the region of interest. Accordingly, it is possible to easily identify an analysis method corresponding to a region of interest corresponding to an analysis result when an analysis process is performed using the analysis unit 270.

In addition, the detection unit 240 may detect a region of interest on the basis of a detection parameter. The detection parameter mentioned here refers to a parameter that can be adjusted in accordance with a state of a captured image that changes in accordance with a state, an observation condition of an observation target, or the like, a photographing condition or specifications of the imaging device 10, or the like. More specifically, detection parameters include a scale of a captured image, a size of an observation target, a speed of a motion, a size of cluster formed by an observation target, a random variable, and the like. Such a detection parameter may be automatically adjusted in accordance with, for example, a state or an observation condition of an observation target, or the like as described above, or may be automatically adjusted in accordance with a photographing condition (e.g., an imaging magnification, an imaging frame, brightness, or the like) of the imaging device 10. In addition, the detection parameter may be adjusted by the detection parameter adjustment unit which will be described below.

The detection unit 240 outputs a detection result (information of the region of interest, an identified region, a label, and the like) to the region drawing unit 260 and the analysis unit 270.

### (Detection Parameter Adjustment Unit)

The detection parameter adjustment unit 250 adjusts the detection parameter regarding a detection process of the detection unit 240 in accordance with a state or an observation condition of the observation target, an imaging condition of the imaging device 10, or the like as described above. The detection parameter adjustment unit 250 may automatically adjust the detection parameter, for example, in accordance with each state and condition described above, or may adjust the detection parameter through a user operation.

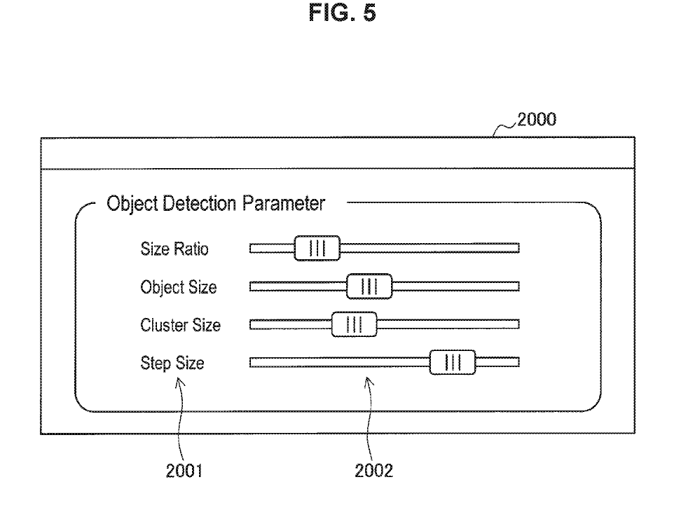

FIG. 5 is a diagram showing an example of an interface for inputting adjustment details into the detection parameter adjustment unit 250 according to the present embodiment. As shown in FIG. 5, an interface 2000 for adjusting detection parameters includes detection parameter types 2001 and sliders 2002. The detection parameter types 2001 include Size Ratio (a reduction ratio of a captured image), Object Size (a threshold value of a detection size), Cluster Size (a threshold value for determining whether observation targets corresponding to a detected region of interest are the same), and Step Size (a frame unit of a detection process). In addition, other detection parameters such as a threshold of luminance or the like may also be included in the detection parameter types 2001 as an adjustment object. These detection parameters are modified by operating the sliders 2002.

The detection parameters adjusted by the detection parameter adjustment unit 250 are output to the detection unit 240.

### (Region Drawing Unit)

The region drawing unit 260 superimposes the detection result such as the region of interest, the identified region, and the ID on the captured image that is subject to the detection process of the detection unit 240. The region drawing unit 260 may indicate the region of interest, the identified region, and the like using, for example, straight lines, curves, or figures such as a plane that is closed by a curve, or the like. The shape of the plane indicating such a region may be, for example, an arbitrary shape such as a rectangle, a circle, an oval, or the like, or may be a shape formed in accordance with contours of a region corresponding to an observation target. In addition, the region drawing unit 260 may cause the ID to be displayed in the vicinity of the region of interest or the identified region. A specific drawing process performed by the region drawing unit 260 will be described below. The region drawing unit 260 outputs a result of the drawing process to the output control unit 280.

### (Analysis Unit)

The analysis unit 270 analyzes the region of interest (and the identified region) detected by the detection unit 240. The analysis unit 270 analyzes the region of interest on the basis of, for example, an analysis method associated with a detector used in detection of the region of interest. Analysis performed by the analysis unit 270 is analysis for quantitatively evaluating, for example, growth, proliferation, division, cell death, movements, shape changes of cells that are observation targets. In this case, the analysis unit 270 calculates, for example, a feature amount such as a size, an area, the number, a shape (e.g., circularity), and a motion vector of cells from the region of interest or the identified region.

Referring to FIG. 4, in a case in which scratch assay is performed with respect to cancer cells, for example, the analysis unit 270 analyzes a degree of migration or infiltration occurring in the region of interest corresponding to the cancer cells. Specifically, the analysis unit 270 analyzes a region in which the phenomenon of migration or infiltration occurs among regions of interest corresponding to the cancer cells. The analysis unit 270 calculates an area, a size, a motion vector, and the like of the region as a feature amount of the region of interest or the region in which the phenomenon of migration or infiltration is occurring.

In addition, in a case in which efficacy evaluation is performed with respect to cardiac muscle cells, for example, the analysis unit 270 analyzes each of a region in which rhythms are occurring, a region in which proliferation (division) is occurring, and a region in which cell death are occurring among regions of interest corresponding to the cardiac muscle cells. More specifically, the analysis unit 270 may analyze the size of rhythms of the region in which rhythms are occurring, analyze a speed of differentiation of the region in which proliferation is occurring, and analyze the size of the region in which cell death is occurring. In this manner, the analysis unit 270 may perform analysis with respect to each of detection results obtained using each of detectors obtained by the detection unit 240. Accordingly, a plurality of kinds of analysis can be performed for a single type of cells at a time, evaluation that requires a plurality of kinds of analysis can be comprehensively performed.

The analysis unit 270 outputs the analysis results including the calculated feature amount and the like to the output control unit 280.

### (Output Control Unit)

The output control unit 280 outputs drawing information (the captured image on which the region is superimposed, or the like) acquired from the region drawing unit 260 and the analysis result acquired from the analysis unit 270 as output data. The output control unit 280 may display the output data on, for example, a display unit (not illustrated) provided inside or outside the information processing device 20-1. In addition, the output control unit 280 may store the output data in a storage unit (not illustrated) provided inside or outside the information processing device 20-1. Furthermore, the output control unit 280 may transmit the output data to an external device (a server, a cloud, or a terminal device) or the like via a communication unit (not illustrated) provided in the information processing device 20-1.

In a case in which the output data is displayed on the display unit, for example, the output control unit 280 may display the captured image including a figure indicating at least any of the region of interest or the identified region, and the ID superimposed by the region drawing unit 260.

In addition, the output control unit 280 may output the analysis result acquired from the analysis unit 270 in association with the region of interest. For example, the output control unit 280 may output the analysis result with an ID for identifying the region of interest attached. Accordingly, the observation target corresponding to the region of interest can be output in association with the analysis result.

Furthermore, the output control unit 280 may process the analysis result acquired from the analysis unit 270 into a table, a graph, a chart, or the like for output, or into a data file appropriate for analysis to be performed by another analysis device for output.

In addition, the output control unit 280 may further superimpose a mark indicating the analysis result on the captured image including the figure indicating the region of interest and output the result. For example, the output control unit 280 may superimpose a heat map on which specific motions of an observation target are categorized in different colors in accordance with analysis results of the motions (e.g., sizes of motions) on the captured image for output. Accordingly, when the captured image is displayed on the display unit, the analysis results of the observation target can be intuitively understood by visually recognizing the captured image.

Note that an example of output performed by the output control unit 280 will be described below in detail.

### 2.2. Example of Process of Information Processing Device

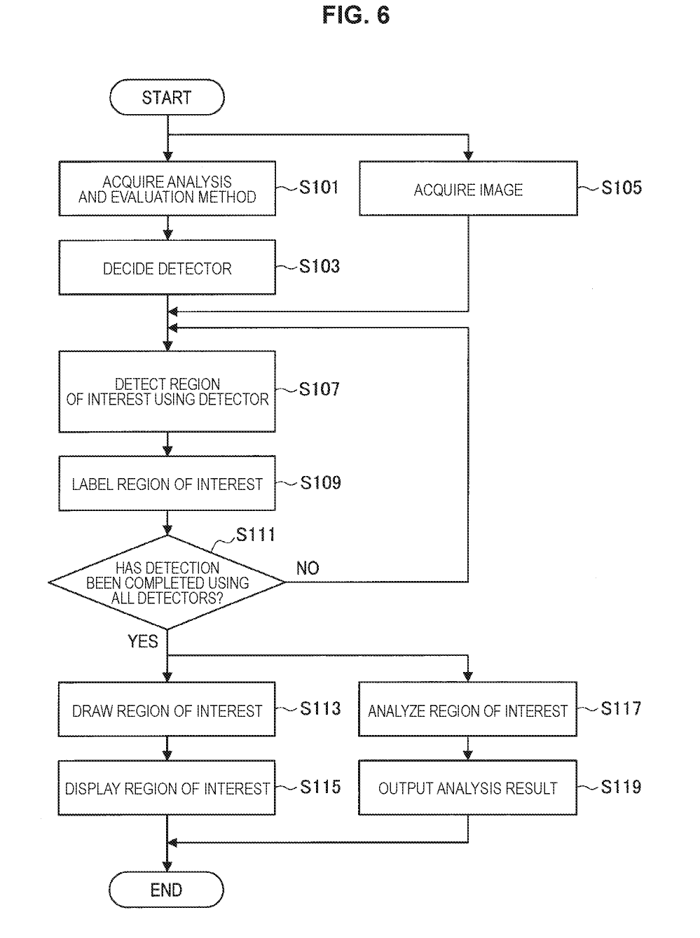

The example of the configuration of the information processing device 20-1 according to the embodiment of the present disclosure has been described above. Next, an example of a process performed by the information processing device 20-1 according to an embodiment of the present disclosure will be described with reference to FIG. 6 to FIG. 9.

FIG. 6 is a flowchart showing an example of a process performed by the information processing device 20-1 according to the first embodiment of the present disclosure. First, the analysis method acquisition unit 210 acquires information regarding an analysis method through a user operation, batch processing, or the like (S101). Next, the detector decision unit 220 acquires the information regarding the analysis method from the analysis method acquisition unit 210 and selects and decides a detection recipe associated with the analysis method from the detector DB 200 (S103).

Then, the image acquisition unit 230 acquires data regarding a captured image generated by the imaging device 10 via a communication unit that is not illustrated (S105).

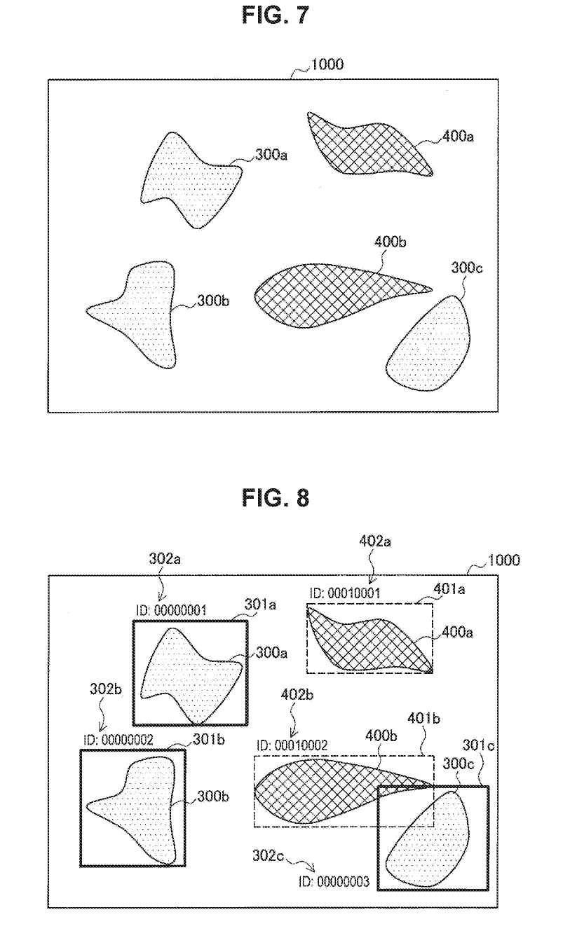

FIG. 7 is a diagram showing an example of the captured image generated by the imaging device 10 according to the present embodiment. As shown in FIG. 7, the captured image 1000 includes cancer cell (carcinoma) regions 300a, 300b, and 300c, and immune cell (immune) regions 400a and 400b. This captured image 1000 is a captured image obtained by the imaging device 10 capturing cancer cells and immune cells existing in a culture medium M. In the following process, regions of interest corresponding to the cancer cells and immune cells are detected and analysis is performed with respect to each of the regions of interest.

Returning to FIG. 6, the detection unit 240 next detects regions of interest using a detector included in the detection recipe decided by the detector decision unit 220 (S107). Then, the detection unit 240 labels the detected regions of interest (S109).

Note that, in a case in which the detection recipe includes a plurality of detectors, the detection unit 240 detects regions of interest using all the detectors (S111). In the example shown in FIG. 7, for example, the detection unit 240 uses two detectors which are a detector for detecting the cancer cells and a detector for detecting the immune cells.

After the detection process is performed using all the detectors (YES in S111), the region drawing unit 260 draws the regions of interest and IDs associated with the regions of interest in the captured image used in the detection process (S113).

FIG. 8 is a diagram showing an example of a drawing process performed by the region drawing unit 260 according to the present embodiment. As shown in FIG. 8, rectangular regions of interest 301a, 301b, and 301c are drawn around the cancer cell regions 300a, 300b, and 300c. In addition, rectangular regions of interest 401a, 401b, and 401c are drawn around the immune cell regions 400a, 400b, and 400c. For the purpose of clearly distinguish the types of the cells, for example, the region drawing unit 260 may change contour lines indicating the regions of interest to solid lines, dashed lines, or the like as shown in FIG. 8, or change colors of the contour lines. In addition, the region drawing unit 260 may give IDs indicating the regions of interest close positions to each of the regions of interest 301 and 401 (outside the range of the regions of interest in the example shown in FIG. 8a). For example, IDs 302a, 302b, 302c, 402a, and 402b may be given at positions adjacent to the regions of interest 301a, 301b, 301c, 401a, and 401b.

In the example shown in FIG. 8, the ID 302a is displayed as “ID: 00000001” and the ID 402a is displayed as “ID: 00010001.” In this manner, the regions of interest can be distinguished from each other in accordance with the types of cells by changing numbers in the fifth digit. Note that IDs are not limited to the above-descried example, and numbers may be given so that the regions can be easily distinguished in accordance with a type of analysis, a state of cells, or the like.

Returning to FIG. 6, the output control unit 280 outputs drawing information of the region drawing unit 260 (S115).

In addition, the analysis unit 270 analyzes the regions of interest detected by the detection unit 240 (S117). Next, the output control unit 280 outputs analysis results of the analysis unit 270 (S119).

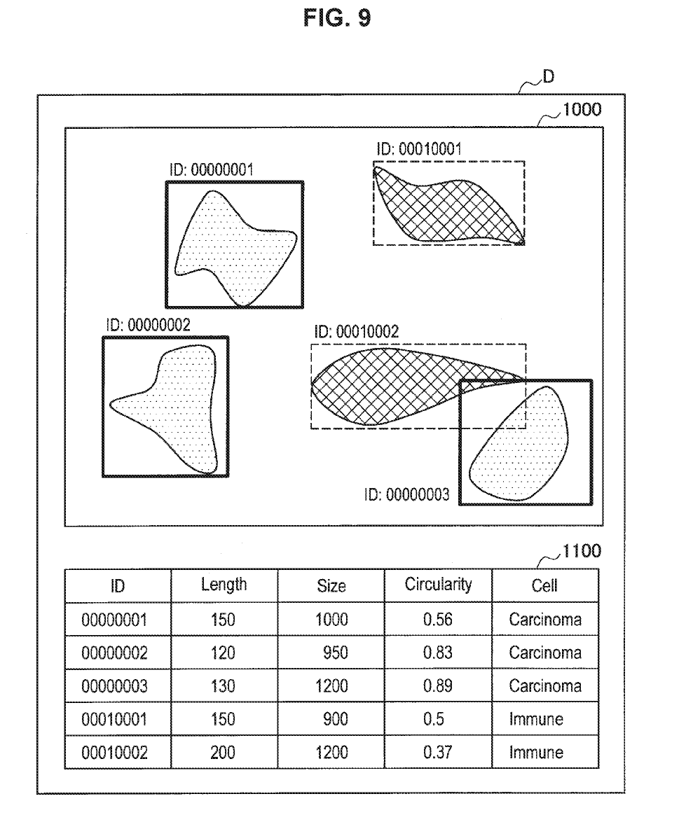

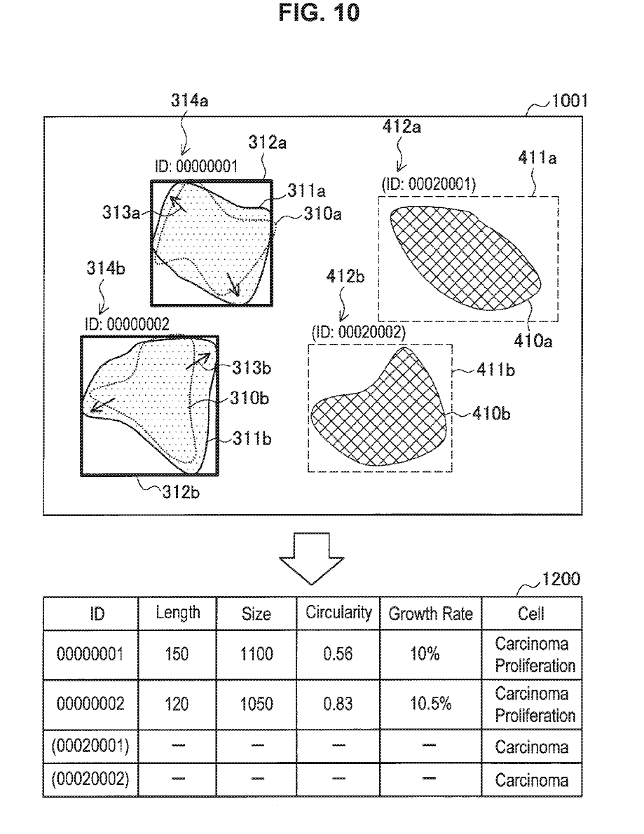

FIG. 9 is a diagram showing an example of output of the output control unit 280 according to the present embodiment. As shown in FIG. 9, a display unit D (provided inside or outside the information processing device 20-1) includes the captured image 1000 that has undergone the drawing process performed by the region drawing unit 260 and a table 1100 indicating the analysis results from the analysis unit 270. The regions of interest and their IDs are superimposed on the captured image 1000. In addition, the table 1100 indicating the analysis results shows lengths (Length), sizes (Size), and circularity (Circularity) of the regions of interest corresponding to the IDs, and types of cells. In the row of the ID “00000001” of the table 1100, for example, the length (150), the size (1000), the circularity (0.56), and the type of the cancer cells (Carcinoma) of the cancer cells to which the ID “ID: 00000001” is given in the captured image 1000 are displayed. In this manner, the output control unit 280 may output the analysis results as a table, or the output control unit 280 may output the analysis results in a form of graphs, mapping, or the like.

### 2.3. Effect

The examples of configuration and process of the information processing device 20-1 according to the first embodiment of the present disclosure have been described. According to the present embodiment, a detection recipe (a detector) is decided in accordance with an analysis method acquired by the analysis method acquisition unit 210, regions of interest are detected from a captured image using a detector decided by the detection unit 240, and the analysis unit 270 analyzes the regions of interest. Accordingly, a user can detect an observation target from the captured image and analyze the observation target only by deciding the analysis method for the observation target. By deciding the detector on the basis of the analysis method, the detector appropriate for a shape and a state of each observation target that changes in accordance with an elapse of time is selected. Accordingly, the observation target can be analyzed with high accuracy regardless of a change of the observation target. In addition, since the detector appropriate for detection of a change of the observation target is automatically selected when the analysis method is selected, convenience for a user who wants to analyze a change of the observation target can also be improved.

### 2.4. Application Example

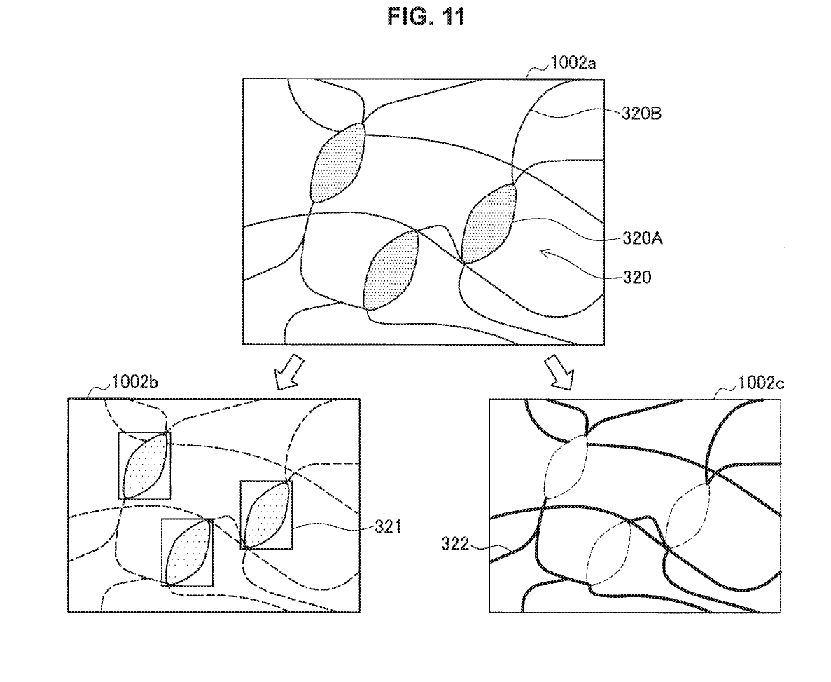

Next, application examples of the process performed by the information processing device 20-1 according to the first embodiment of the present disclosure will be described with reference to FIG. 10 and FIG. 11.

### (First Example of Narrowing Process for Region of Interest by Plurality of Detectors)

First, a first example of a narrowing process for regions of interest performed by a plurality of detectors will be described. In the present application example, first, the detection unit 240 detects a plurality of regions of interest of cells using one detector, and further the detection unit 240 narrows a region of interest corresponding to an observation target showing a specific change from the detected regions of interest using another detector. Accordingly, only the region of interest corresponding to the observation target showing the specific change can be subject to analysis from the plurality of regions of interest. Thus, cancer cells among the plurality of cancer cells, for example, that are proliferating and undergoing cell death can be distinguished from each other and thus the cancer cells can be analyzed.

FIG. 10 is a diagram showing a first output example of a narrowing process for regions of interest performed by a plurality of detectors according to the present embodiment. Referring to FIG. 10, a capture image 1001 includes cancer cell regions 311a, 311b, 410a, and 410b. Among these, the cancer cell regions 311a and 311b are regions that have changed from cancer cell regions 310a and 310b of one previous frame due to proliferation or the like of cancer cells. Meanwhile, the cancer cell regions 410a and 410b show no changes (which are attributable to, e.g., cell death or inactivity).

In this case, the detection unit 240 first detects regions of interest using a detector (the cell region detector) for detecting cancer cell regions. Then, the detection unit 240 further narrows a region of interest in which a proliferation phenomenon is occurring from the previously detected regions of interest using a detector (the proliferation region detector) for detecting a region in which cells are proliferating.

In the example shown in FIG. 10, regions of interest 312a and 312b are drawn around the cancer cell regions 311a and 311b. In addition, motion vectors 313a and 313b that are feature amounts indicating motions are drawn inside the regions of interest 312a and 312b. Meanwhile, although rectangular regions 411a and 411 b are drawn around the cancer cell regions 410a and 410b, the line type of the rectangular regions 411 is set to be different from the line type of the regions of interest 312. Accordingly, it is possible to indicate that analysis targets are narrowed down even though there is the same type of cells.

In addition, a table 1200 showing analysis results displays only analysis results corresponding to the narrowed regions of interest 312. Furthermore, the table 1200 displays growth rates of the cancer cells corresponding to the regions of interest 312. In addition, states of the cancer cells corresponding to the regions of interest 312 are indicated as “Carcinoma Proliferation,” and thus the fact that the cancer cells are in a proliferation state is displayed in the table 1200.

As described above, only cells showing a specific change among a certain type of cells can be detected according to the present application example. Thus, in a case in which a specific change is desired to be analyzed, only cells showing the specific change can be analyzed.

### Application Example 2: Second Example of Narrowing Process for Region of Interest by Plurality of Detectors

Next, a second example of the narrowing process for regions of interest performed by a plurality of detectors will be described. In the present application example, the detection unit 240 detects a plurality of regions of interest of one type of cells using the plurality of detectors. Accordingly, even in a case in which cells of one type have a plurality of different characteristics, regions of interest detected in accordance with each of the characteristics can be analyzed. Thus, even in a case in which cells of one type have a specific characteristic such as axons, like nerve cells, for example, only regions of axons can be detected and analyzed.

FIG. 11 is a diagram showing a second output example of the narrowing process for regions of interest performed by a plurality of detectors according to the present embodiment. Referring to FIG. 11, captured images 1002 include nerve cell regions 320. A nerve cell includes a nerve cell body and an axon as described above. Since a nerve cell body has a planar structure, nerve cell body regions 320A included in the captured images 1002 are easily detected, however, an axon has a long structure and has a three-dimensionally stretching characteristic, it is difficult to discriminate backgrounds of the captured images 1002 from axon regions 320B as shown in FIG. 11. For this reason, the detection unit 240 according to the present embodiment distinguishes and detects each of the composition elements of the nerve cells by using two detectors which are a detector for detecting the nerve cell body regions and a detector for detecting the axon regions.

In a case in which the detection unit 240 uses the detector for detecting the nerve cell body regions, for example, the detection unit 240 detects regions of interest 321 corresponding to the nerve cell bodies as shown in a captured image 1002b. Meanwhile, in a case in which the detection unit 240 uses the detector for detecting the axon regions, the detection unit 240 detects regions of interest 322 corresponding to the axons as shown in a captured image 1002c. These regions of interest 322 may be drawn using, for example, curves indicating axon regions.

According to the present application example, in the case in which one type of cells has a plurality of characteristics, each of the cells can be distinguished and detected as described above. Thus, in the case in which certain characteristics of one type of cells are desired to be analyzed, only regions showing the characteristics can be analyzed.

### 3. SECOND EMBODIMENT

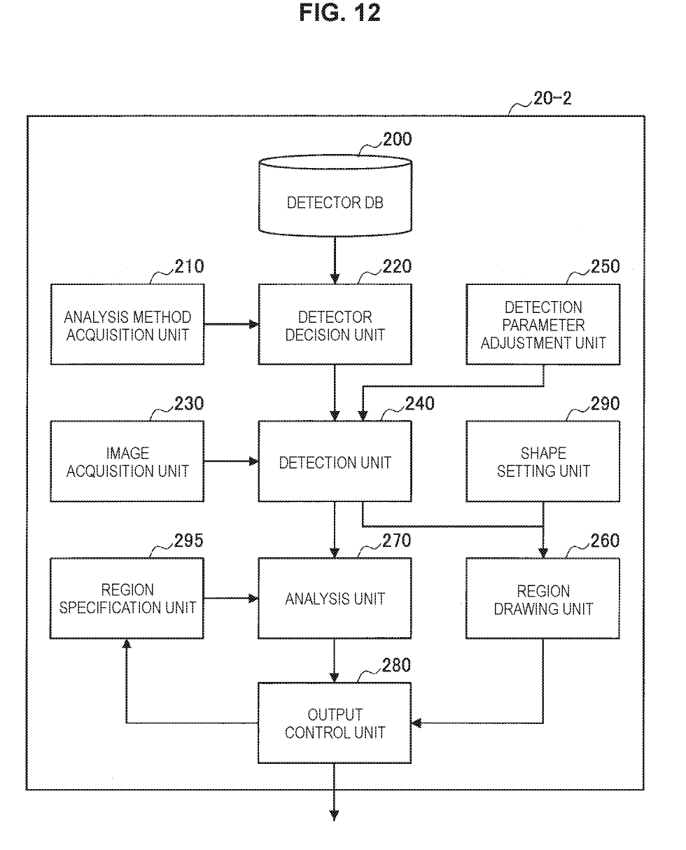

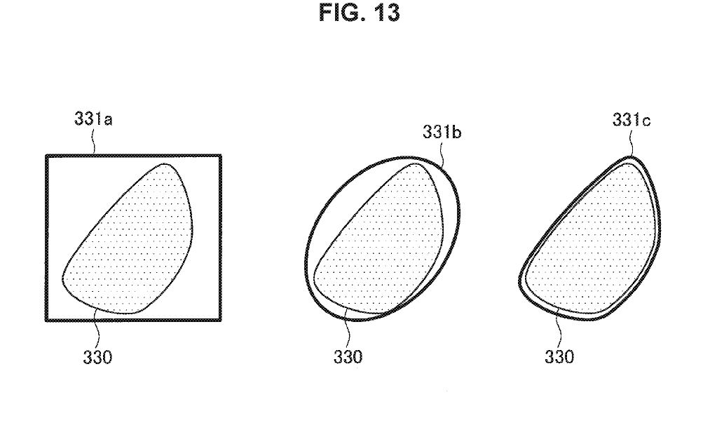

Next, an information processing device 20-2 according to a second embodiment of the present disclosure will be described with reference to FIG. 12 to FIG. 14.

### 3.1. Example of Configuration of Information Processing Device

FIG. 12 is a block diagram showing an example of a configuration of the information processing device 20-2 according to the second embodiment of the present disclosure. As shown in FIG. 12, the information processing device 20-2 further includes a shape setting unit 290 and a region specification unit 295 in addition to the detector database (DB) 200, the analysis method acquisition unit 210, the detector decision unit 220, the image acquisition unit 230, the detection unit 240, the detection parameter adjustment unit 250, the region drawing unit 260, the analysis unit 270, and the output control unit 280. Functions of the shape setting unit 290 and the region specification unit 295 will be described below.

### (Shape Setting Unit)

The shape setting unit 290 sets a shape of a mark indicating a region of interest drawn by the region drawing unit 260.

FIG. 13 is a diagram showing an example related to a shape setting process for a region of interest performed by the shape setting unit 290 according to the present embodiment. As shown in FIG. 13, a region of interest 331 is drawn around an observation target region 330. The shape setting unit 290 may set a shape of the mark indicating the regions of interest 331 to, for example, a rectangle (a region 331a) or an oval (a region 331b).

In addition, the shape setting unit 290 may detect a region corresponding to contours of the observation target region 330 through image analysis performed on a captured image (not shown) and set a shape obtained on the basis of the detection result as a shape of the regions of interest 331. For example, as shown in FIG. 13, the shape setting unit 290 may detect contours of the observation target region 330 through image analysis and then set a shape indicated by a closed curve (or a curve) indicating the detected contours as a shape of the regions of interest 331 (e.g., a region 331c). Accordingly, the observation target region 330 and the regions of interest 331 can be more closely associated on the captured image. Note that, in order to fit the contours of the observation target region 330 more precisely, a curve fitting technique, for example, Snakes or Level Set, can be used.

Information regarding the shape decided by the shape setting unit 290 is output to the region drawing unit 260.

Note that the above-described shape setting process for regions of interest based on the shape of contours of the observation target region may be performed by the region drawing unit 260. In this case, the region drawing unit 260 may set a shape of the regions of interest using a detection result of the regions of interest from the detection unit 240. Accordingly, the detection result can be used in setting a shape of the regions of interest without change, and thus it is not necessary to execute image analysis on the captured image again.

### (Region Specification Unit)

The region specification unit 295 specifies a region of interest, which is subject to analysis performed by the analysis unit 270, from regions of interest detected by the detection unit 240. For example, the region specification unit 295 specifies a region of interest, which is subject to analysis, among a plurality of regions of interest detected by the detection unit 240 in accordance with a user operation or a predetermined condition. Then, the analysis unit 270 analyzes the region of interest specified by the region specification unit 295. More specifically, in a case in which a region of interest is specified through a user operation, the region specification unit 295 selects a region of interest to be specified among a plurality of regions of interest displayed by the output control unit 280 through a user operation and then the analysis unit 270 analyzes the selected region of interest.

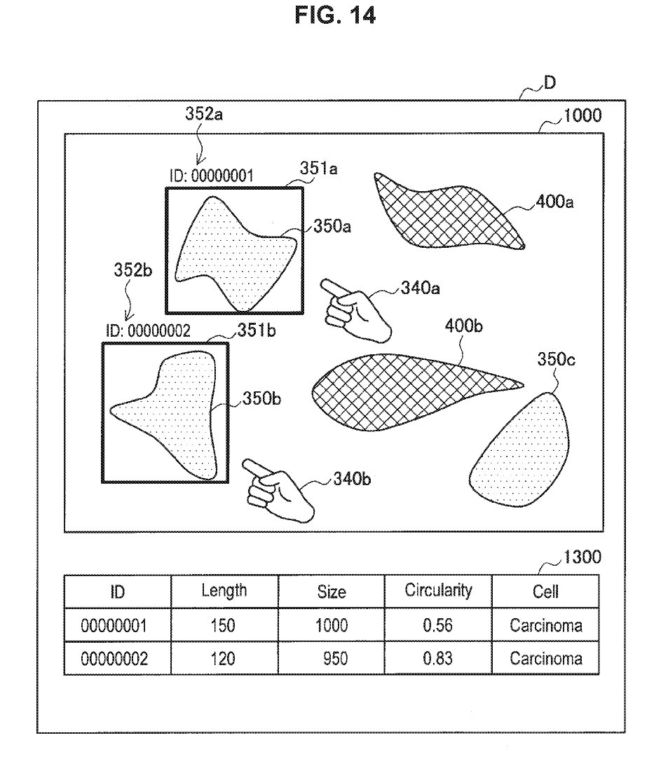

FIG. 14 is a diagram showing an example related to a specification process of a region of interest performed by the region specification unit 295 according to the present embodiment. As shown in FIG. 14, a display unit D includes a captured image 1000 and a table 1300 showing analysis results. The captured image 1000 includes cancer cell regions 350a, 350b, and 350c, and other cell regions 400a and 400b. Here, the detection unit 240 is assumed to have detected regions of interest corresponding to the cancer cell regions 300. In this case, initially, the region drawing unit 260 draws each of the regions of interest around the cancer cell regions 350a, 350b, and 350c and the output control unit 280 causes each of the regions of interest to be displayed. At this time, the region specification unit 295 is assumed to select a region of interest 351a corresponding to the cancer cell region 350a and a region of interest 351b corresponding to the cancer cell region 350b as regions of interest which will be subject to analysis. In this case, since a region of interest corresponding to the cancer cell region 350b is assumed to be excluded from the selection, the region is not analyzed. Accordingly, only the selected regions of interest 351a and 351b are analyzed.

The table 1300 includes description regarding IDs corresponding to the regions of interest 351a and 352b (correspond to IDs 352a and 352b), lengths, sizes, circularities, and types of cells of the regions of interest. The table 1300 displays only analysis results with regard to the regions of interest specified by the region specification unit 295. Note that, similarly to the above-described selection of regions of interest, the table 1300 may display analysis results with regard to all detected regions of interest before a region specification process performed by the region specification unit 295. In this case, an analysis result with regard to a region of interest that is not specified by the region specification unit 295 may be removed from the table 1300. In addition, the region specification unit 295 may specify a region of interest, which has been removed from analysis targets before, as an analysis target by selecting the region of interest again. In that case, an analysis result of the region of interest may be displayed in the table 1300 again. Accordingly, a necessary analysis result can be freely selected, and an analysis result necessary for evaluation can be extracted. In addition, for example, analysis results of a plurality of regions of interest can be compared with each other, such comparison of the analysis results can enable new analysis.

Note that marks 340 (340a and 340b) for indicating the regions of interest specified by the region specification unit 295 may be displayed near the regions of interest 351 on the captured image 1000 of the display unit D. Accordingly, it is possible to ascertain which region of interest has been specified as an analysis target.

### 3.2. Effect

The example of the configuration of the information processing device 20-2 according to the second embodiment of the present disclosure has been described. According to the present embodiment, a shape of a figure defining a region of interest can be set, and, for example, a shape that fits to contours of an observation target region can also be set as a shape of the region of interest. Accordingly, the observation target region and the region of interest can be analyzed in close association. In addition, according to the present embodiment, a region of interest that is subject to analysis can be specified among detected regions of interest. Accordingly, an analysis result necessary for evaluation can be extracted or analysis results can be compared.

Note that, although the information processing device 20-2 according to the present embodiment includes the shape setting unit 290 and the region specification unit 295 together, the present technology is not limited thereto. For example, the information processing device may have a configuration of the information processing device according to the first embodiment of the present disclosure to which only the shape setting unit 290 is further added or only the region specification unit 295 is further added.

### 4. EXAMPLE OF HARDWARE CONFIGURATION

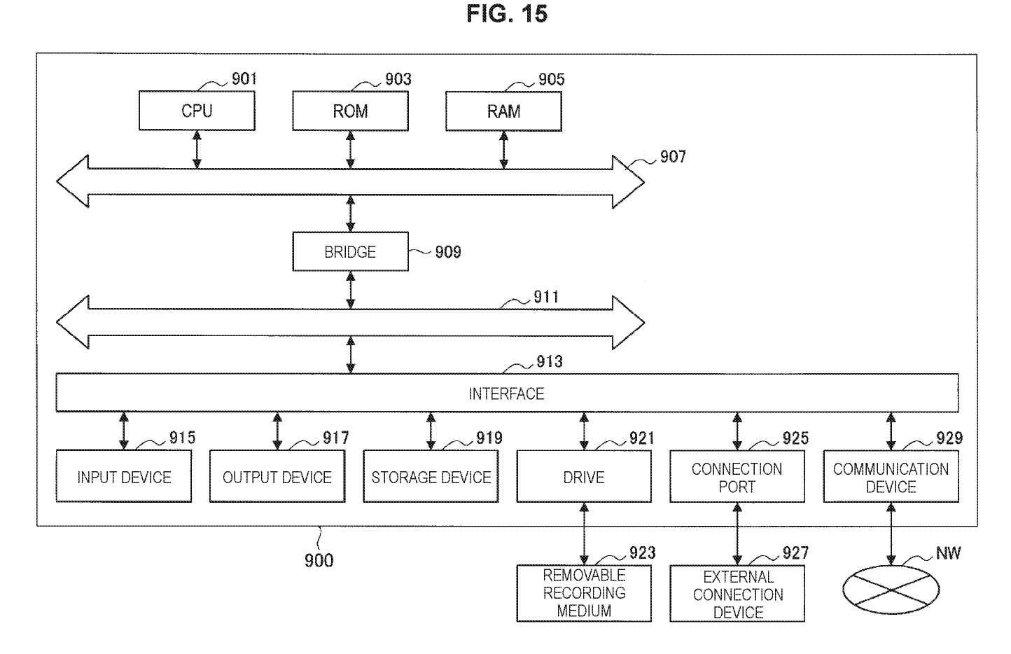

Next, with reference to FIG. 15, a hardware configuration of an information processing device according to an embodiment of the present disclosure is described. FIG. 15 is a block diagram showing a hardware configuration example of the information processing device according to the embodiment of the present disclosure. An illustrated information processing device 900 can realize the information processing device 20 in the above described embodiment.

The information processing device 900 includes a central processing unit (CPU) 901, read only memory (ROM) 903, and random access memory (RAM) 905. In addition, the information processing device 900 may include a host bus 907, a bridge 909, an external bus 911, an interface 913, an input device 915, an output device 917, a storage device 919, a drive 921, a connection port 925, and a communication device 929. The information processing device 900 may include a processing circuit such as a digital signal processor (DSP) or an application-specific integrated circuit (ASIC), instead of or in addition to the CPU 901.

The CPU 901 functions as an arithmetic processing device and a control device, and controls the overall operation or a part of the operation of the information processing device 900 according to various programs recorded in the ROM 903, the RAM 905, the storage device 919, or a removable recording medium 923. For example, the CPU 901 controls overall operations of respective function units included in the information processing device 20 of the above-described embodiment. The ROM 903 stores programs, operation parameters, and the like used by the CPU 901. The RAM 905 transiently stores programs used when the CPU 901 is executed, and parameters that change as appropriate when executing such programs. The CPU 901, the ROM 903, and the RAM 905 are connected with each other via the host bus 907 configured from an internal bus such as a CPU bus or the like. The host bus 907 is connected to the external bus 911 such as a Peripheral Component Interconnect/Interface (PCI) bus via the bridge 909.

The input device 915 is a device operated by a user such as a mouse, a keyboard, a touchscreen, a button, a switch, and a lever. The input device 915 may be a remote control device that uses, for example, infrared radiation and another type of radio waves. Alternatively, the input device 915 may be an external connection device 927 such as a mobile phone that corresponds to an operation of the information processing device 900. The input device 915 includes an input control circuit that generates input signals on the basis of information which is input by a user to output the generated input signals to the CPU 901. The user inputs various types of data and indicates a processing operation to the information processing device 900 by operating the input device 915.

The output device 917 includes a device that can visually or audibly report acquired information to a user. The output device 917 may be, for example, a display device such as a LCD, a PDP, and an OLED, an audio output device such as a speaker and a headphone, and a printer. The output device 917 outputs a result obtained through a process performed by the information processing device 900, in the form of text or video such as an image, or sounds such as audio sounds.

The storage device 919 is a device for data storage that is an example of a storage unit of the information processing device 900. The storage device 919 includes, for example, a magnetic storage device such as a hard disk drive (HDD), a semiconductor storage device, an optical storage device, or a magneto-optical storage device. The storage device 919 stores therein the programs and various data executed by the CPU 901, and various data acquired from an outside.

The drive 921 is a reader/writer for the removable recording medium 923 such as a magnetic disk, an optical disc, a magneto-optical disk, and a semiconductor memory, and built in or externally attached to the information processing device 900. The drive 921 reads out information recorded on the mounted removable recording medium 923, and outputs the information to the RAM 905. The drive 921 writes the record into the mounted removable recording medium 923.

The connection port 925 is a port used to directly connect devices to the information processing device 900. The connection port 925 may be a Universal Serial Bus (USB) port, an IEEE1394 port, or a Small Computer System Interface (SCSI) port, for example. The connection port 925 may also be an RS-232C port, an optical audio terminal, a High-Definition Multimedia Interface (HDMI (registered trademark)) port, and so on. The connection of the external connection device 927 to the connection port 925 makes it possible to exchange various kinds of data between the information processing device 900 and the external connection device 927.

The communication device 929 is a communication interface including, for example, a communication device for connection to a communication network NW. The communication device 929 may be, for example, a wired or wireless local region network (LAN), Bluetooth (registered trademark), or a communication card for a wireless USB (WUSB). The communication device 929 may also be, for example, a router for optical communication, a router for asymmetric digital subscriber line (ADSL), or a modem for various types of communication. For example, the communication device 929 transmits and receives signals in the Internet or transits signals to and receives signals from another communication device by using a predetermined protocol such as TCP/IP. The communication network NW to which the communication device 929 connects is a network established through wired or wireless connection. The communication network NW is, for example, the Internet, a home LAN, infrared communication, radio wave communication, or satellite communication.

The example of the hardware configuration of the information processing device 900 has been described. Each of the structural elements described above may be configured by using a general purpose component or may be configured by hardware specialized for the function of each of the structural elements. The configuration may be changed as necessary in accordance with the state of the art at the time of working of the present disclosure.

### 5. CONCLUSION

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

For example, although the information processing system 1 is configured to be provided with the imaging device 10 and information processing device 20 in the above-described embodiment, the present technology is not limited thereto. For example, the imaging device 10 may have the function of the information processing device 20 (the detection function and the analysis function). In this case, the information processing system 1 is realized by the imaging device 10. In addition, the information processing device 20 may have the function of the imaging device 10 (imaging function). In this case, the information processing system 1 is realized by the information processing device 20. Further, the imaging device 10 may have a part of the function of the information processing device 20, and the information processing device 20 may have a part of the function of the imaging device 10.

In addition, although a cell is exemplified as an observation target for analysis of the information processing system 1 in the embodiments, the present technology is not limited thereto. The observation target may be, for example, a cell organelle, a biological tissue, an organ, a human, an animal, a plant, a non-living structure, or the like, and in the case where the structure of shape thereof change in a short period of time, changes of the observation targets can be analyzed using the information processing system 1.

The steps in the processes performed by the information processing device in the present specification may not necessarily be processed chronologically in the orders described in the flowcharts. For example, the steps in the processes performed by the information processing device may be processed in different orders from the orders described in the flowcharts or may be processed in parallel.

Also, a computer program causing hardware such as the CPU, the ROM, and the RAM included in the information processing device to carry out the equivalent functions as the above-described configuration of the information processing device provided with an adjustment instruction specifying unit can be generated. Also, a storage medium having the computer program stored therein can be provided.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.

(1)

An information processing device including:

a detector decision unit configured to decide at least one detector in accordance with an analysis method; and

an analysis unit configured to perform analysis according to the analysis method using the at least one detector decided by the detector decision unit.

(2)

The information processing device according to (1), further including:

a detection unit configured to detect a region of interest in a captured image using the at least one detector decided by the detector decision unit,

in which the analysis unit performs analysis with respect to the region of interest.

(3)

The information processing device according to (2), in which, in a case in which the detector decision unit has decided a plurality of detectors, the detection unit decides the region of interest on a basis of a plurality of detection results obtained using the plurality of detectors.

(4)

The information processing device according to (2) or (3), in which the detection unit associates the region of interest detected using the detector with an analysis result obtained through analysis on the region of interest performed by the analysis unit.

(5)

The information processing device according to any one of (2) to (4), further including:

a detection parameter adjustment unit configured to adjust a detection parameter of the detector,

in which the detection unit detects the region of interest in the captured image on a basis of the detection parameter of the decided detector.

(6)

The information processing device according to any one of (2) to (5), further including:

an output control unit configured to output an analysis result of the analysis unit in association with a region of interest corresponding to the analysis result.

(7)

The information processing device according to (6), further including:

a region drawing unit configured to draw a mark indicating the region of interest in the captured image on a basis of a result of detection performed by the detection unit,

in which the output control unit outputs the captured image including the mark corresponding to the region of interest drawn by the region drawing unit.

(8)

The information processing device according to (7), in which a shape of the mark corresponding to the region of interest includes a shape detected on a basis of image analysis with respect to the captured image.

(9)

The information processing device according to (7), in which a shape of the mark corresponding to the region of interest includes a shape calculated on a basis of a result of detection of the region of interest performed by the detection unit.

(10)

The information processing device according to any one of (2) to (9), further including:

a region specification unit configured to specify a region of interest that is subject to analysis to be performed by the analysis unit, from the detected region of interest.

(11)

The information processing device according to any one of (2) to (10),

in which the detector is a detector generated through machine learning in which a set of the analysis method and image data regarding an analysis target to be analyzed using the analysis method is used as learning data, and

the detection unit detects the region of interest on a basis of characteristic data obtained from the captured image using the detector.

(12)

The information processing device according to any one of (1) to (11), in which the detector decision unit decides at least one detector in accordance with a type of change shown by an analysis target to be analyzed using the analysis method.

(13)

The information processing device according to (12), in which the analysis target to be analyzed using the analysis method includes a cell, a cell organelle, or a biological tissue including the cell.

(14)

An information processing method including:

deciding at least one detector in accordance with an analysis method; and

performing analysis according to the analysis method using the at least one decided detector.

(15)

An information processing system including:

an imaging device that includes
an imaging unit configured to generate a captured image; and

an information processing device that includes
a detector decision unit configured to decide at least one detector in accordance with an analysis method, and
an analysis unit configured to perform analysis on the captured image in accordance with the analysis method using the at least one detector decided by the detector decision unit.

### REFERENCE SIGNS LIST

10 imaging device
20 information processing device
200 detector DB
210 analysis method acquisition unit
220 detector decision unit
230 image acquisition unit
240 detection unit
250 detection parameter adjustment unit
260 region drawing unit
270 analysis unit
280 output control unit
290 shape setting unit
295 region specification unit

1. An information processing device comprising:
a detector decision unit configured to decide at least one detector in accordance with an analysis method; and
an analysis unit configured to perform analysis according to the analysis method using the at least one detector decided by the detector decision unit.

2. The information processing device according to claim 1, further comprising:
a detection unit configured to detect a region of interest in a captured image using the at least one detector decided by the detector decision unit,
wherein the analysis unit performs analysis with respect to the region of interest.

3. The information processing device according to claim 2, wherein, in a case in which the detector decision unit has decided a plurality of detectors, the detection unit decides the region of interest on a basis of a plurality of detection results obtained using the plurality of detectors.

4. The information processing device according to claim 2, wherein the detection unit associates the region of interest detected using the detector with an analysis result obtained through analysis on the region of interest performed by the analysis unit.

5. The information processing device according to claim 2, further comprising:
a detection parameter adjustment unit configured to adjust a detection parameter of the detector,
wherein the detection unit detects the region of interest in the captured image on a basis of the detection parameter of the decided detector.

6. The information processing device according to claim 2, further comprising:
an output control unit configured to output an analysis result of the analysis unit in association with a region of interest corresponding to the analysis result.

7. The information processing device according to claim 6, further comprising:
a region drawing unit configured to draw a mark indicating the region of interest in the captured image on a basis of a result of detection performed by the detection unit,
wherein the output control unit outputs the captured image including the mark corresponding to the region of interest drawn by the region drawing unit.

8. The information processing device according to claim 7, wherein a shape of the mark corresponding to the region of interest includes a shape detected on a basis of image analysis with respect to the captured image.

9. The information processing device according to claim 7, wherein a shape of the mark corresponding to the region of interest includes a shape calculated on a basis of a result of detection of the region of interest performed by the detection unit.

10. The information processing device according to claim 2, further comprising:
a region specification unit configured to specify a region of interest that is subject to analysis to be performed by the analysis unit, from the detected region of interest.

11. The information processing device according to claim 2,
wherein the detector is a detector generated through machine learning in which a set of the analysis method and image data regarding an analysis target to be analyzed using the analysis method is used as learning data, and
the detection unit detects the region of interest on a basis of characteristic data obtained from the captured image using the detector.

12. The information processing device according to claim 1, wherein the detector decision unit decides at least one detector in accordance with a type of change shown by an analysis target to be analyzed using the analysis method.

13. The information processing device according to claim 12, wherein the analysis target to be analyzed using the analysis method includes a cell, a cell organelle, or a biological tissue including the cell.

14. An information processing method comprising:
deciding at least one detector in accordance with an analysis method; and
performing analysis according to the analysis method using the at least one decided detector.

15. An information processing system comprising:
an imaging device that includes
an imaging unit configured to generate a captured image; and
an information processing device that includes
a detector decision unit configured to decide at least one detector in accordance with an analysis method, and
an analysis unit configured to perform analysis on the captured image in accordance with the analysis method using the at least one detector decided by the detector decision unit.
